(19) United States
(12) Patent Application Publication
(10) Pub. No.: US 2016/0118904 A1
(43) Pub. Date: Apr. 28, 2016

(54) POWER CONVERSION APPARATUS

(71) Applicant: DENSO CORPORATION, Kariya-city (JP)

(72) Inventors: Satoru Yoshikawa, Nishio-city (JP); Yuji Hayashi, Nishio-city (JP); Masakazu Fukada, Kariya-city (JP); Tatsuya Murakami, Nishio-city (JP)

(21) Appl. No.: 14/887,361

(22) Filed: Oct. 20, 2015

(30) Foreign Application Priority Data
Oct. 24, 2014 (JP) 2014-217207

(51) Int. Cl. H02M 3/335

(52) U.S. Cl. CPC H02M 3/33546

(57) ABSTRACT

In a power conversion apparatus, an AC/DC conversion circuit part converts AC power supplied from an AC input and output part into DC power. A DC/DC conversion circuit part including a transformer converts the DC power supplied from the AC/DC conversion circuit part into AC power, converts converted AC power into DC power after voltage conversion by the transformer and outputs converted DC power to a DC input and output part. A smoothing capacitor is provided in a connection part between the AC/DC conversion circuit part and the DC/DC conversion circuit part to smooth a voltage at the connection part. A connection switchover part changes a maximum value of the AC voltage at the AC input and output part by switching over a connection state between the AC input and output part and an AC device.

### CROSS REFERENCE TO RELATED APPLICATION

This application is based on Japanese patent application No. 2014-217207 filed on Oct. 24, 2014, the disclosure of which is incorporated herein by reference.

### FIELD

The present disclosure relates to a power conversion apparatus, which includes an AC input and output part connected to an AC device such as an AC power source or an AC load and a DC input and output part connected to a DC device such as a DC power source or a DC load and converts electric power bilaterally between the AC device and the DC device.

### BACKGROUND

A conventional power conversion apparatus is capable of converting AC power, which is supplied from an AC power source like a commercial power system, to DC power and supplies the DC power to charge a storage battery or the like. This power conversion apparatus is also capable of converting DC power, which is supplied from a DC power source such as a storage battery, to AC power and supplies the AC power to home electronic devices.

In many instances, a high voltage is supplied to at least one of an AC input and output part and a DC input and output part. The AC input and output part and the DC input and output part are preferably insulated electrically from each other so that the high voltage is not applied to the other output part. For this reason, the power conversion apparatus is configured generally to combine an insulated-type DC/DC conversion circuit part including a transformer and an AC/DC conversion circuit part.

The insulated-type DC/DC conversion circuit part includes a switching circuit provided at a primary side of the transformer and a switching circuit provided at a secondary side of the transformer. By turning on and off plural switching elements provided in the switching circuits, the DC power is converted into the AC power and the AC power is converted into the DC power.

The DC voltage at the DC input and output part varies when a voltage of the storage battery falls, for example. As a result, depending on a varying DC voltage value, the power conversion apparatus tends to be disabled to perform a soft switching operation and high operation efficiency.

To solve this problem, JP 2008-543271 (US 2008/0212340 A1) proposes to configure the insulated-type DC/DC conversion circuit part including the transformer as a TAB circuit, to which an energy buffer is added. With this configuration, it is possible to operate the power conversion apparatus with a comparatively high efficiency even when the DC voltage at the DC input and output part is low, by regulating a magnitude of power drawn into the energy buffer.

In the proposed power conversion apparatus, however, a large current flows in the transformer since large power is drawn into the energy buffer. As a result, copper loss in the transformer increases and impedes improvement in operation efficiency. The proposed power conversion apparatus thus needs be improved for maintaining high operation efficiency.

### SUMMARY

It is therefore an object to provide a power conversion apparatus, which is capable of maintaining high operation efficiency even when a DC voltage at a DC input and output part is low.

According to one aspect, a power conversion apparatus comprises an AC input and output part, a DC input and output part, an AC/DC conversion circuit part, a DC/DC conversion circuit part, a smoothing capacitor and a connection switchover part. The AC input and output part is connectable to an AC device, which is either one of an AC power source and an AC load. The DC input and output part is connectable to a DC device, which is either one of a DC power source and a DC load. The AC/DC conversion circuit part converts AC power supplied from the AC input and output part into the DC power. The DC/DC conversion circuit part includes a transformer and converts the DC power supplied from the AC/DC conversion circuit part into AC power, converts converted AC power into DC power after voltage conversion by the transformer and outputs converted DC power to the DC input and output part. The smoothing capacitor is provided in a connection part between the AC/DC conversion circuit part and the DC/DC conversion circuit part to smooth a voltage at the connection part. The connection switchover part changes a maximum value of the AC voltage at the AC input and output part by switching over a connection state between the AC input and output part and the AC device.

### BRIEF DESCRIPTION OF THE EMBODIMENT

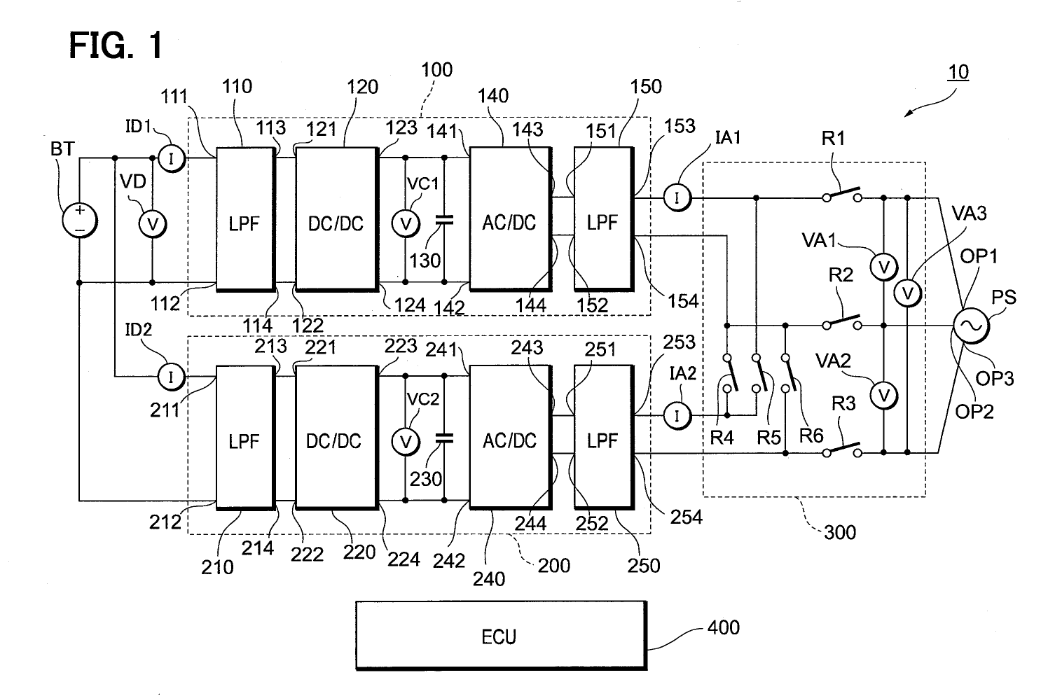

FIG. 1 is a block diagram showing an entire configuration of a power conversion apparatus according to one embodiment;

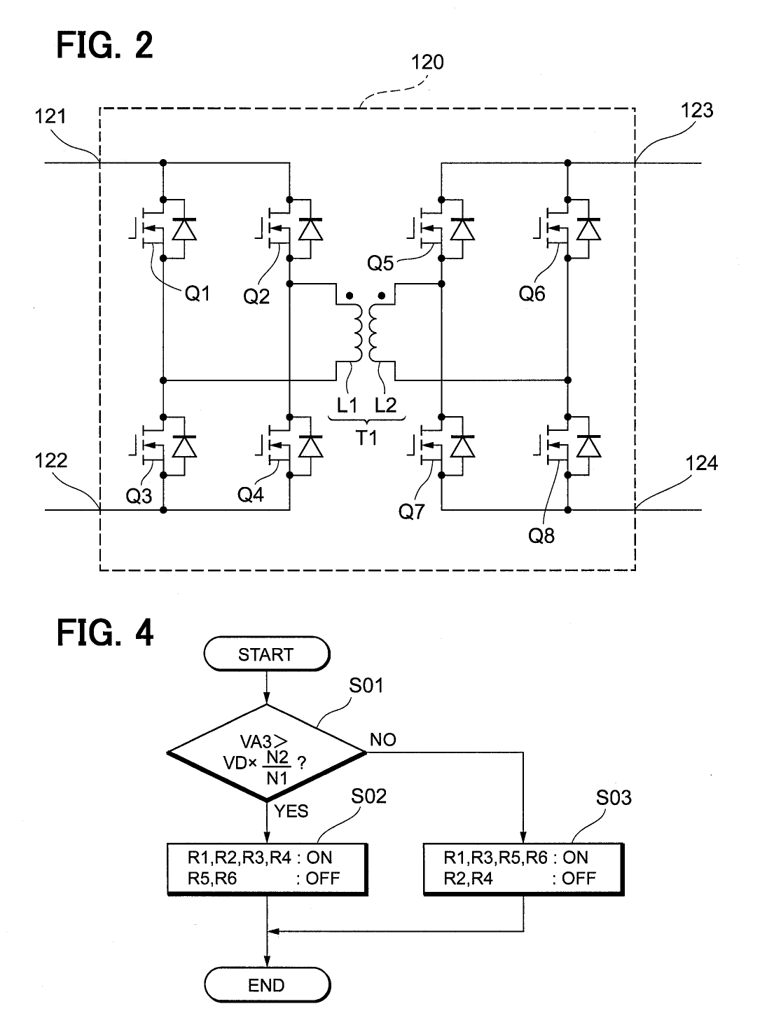

FIG. 2 is a circuit diagram showing an internal configuration of a DC/DC conversion circuit part;

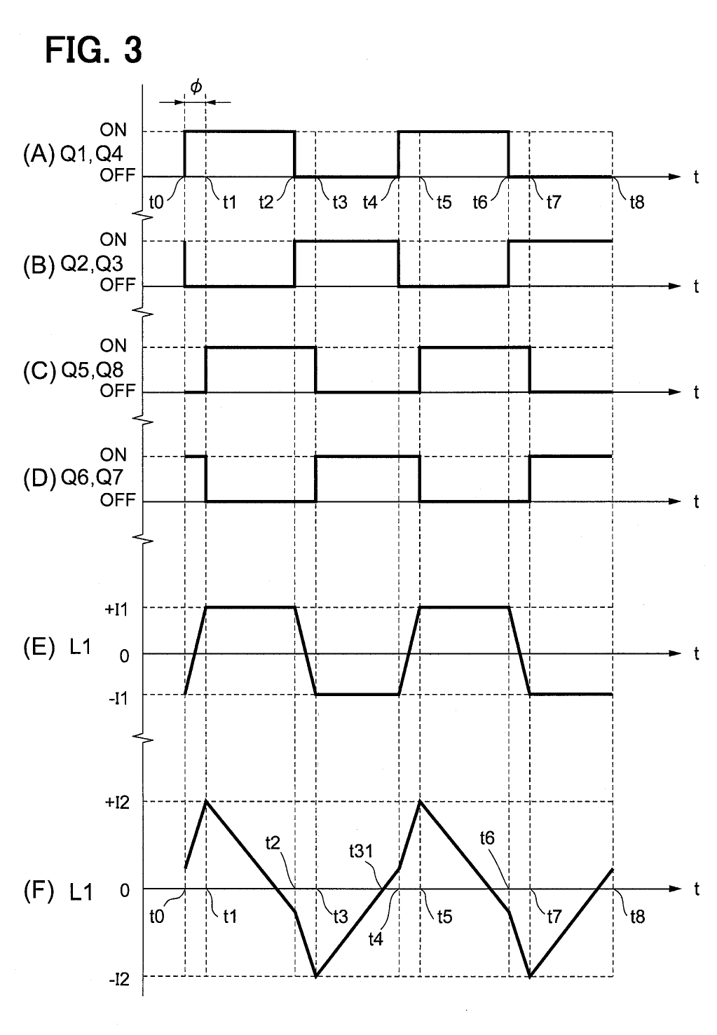

FIG. 3 is a graph showing a relation between a switching operation performed in the DC/DC conversion circuit part and a current of a transformer;

FIG. 4 is a flowchart showing processing performed by a control part;

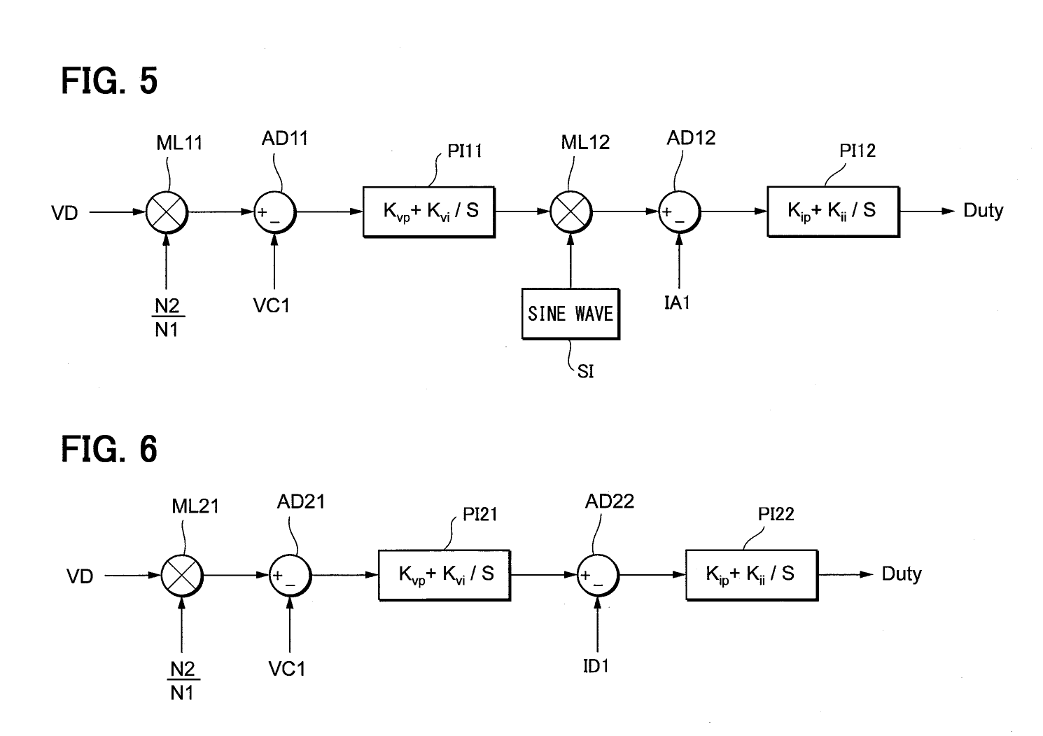

FIG. 5 is a block diagram showing a switching operation performed by an AC/DC conversion circuit part in a case of power conversion from an AC power source side to a storage battery side;

FIG. 6 is a block diagram showing a switching operation performed by a DC/DC conversion circuit part in a case of power conversion from the storage battery side to the AC power source side;

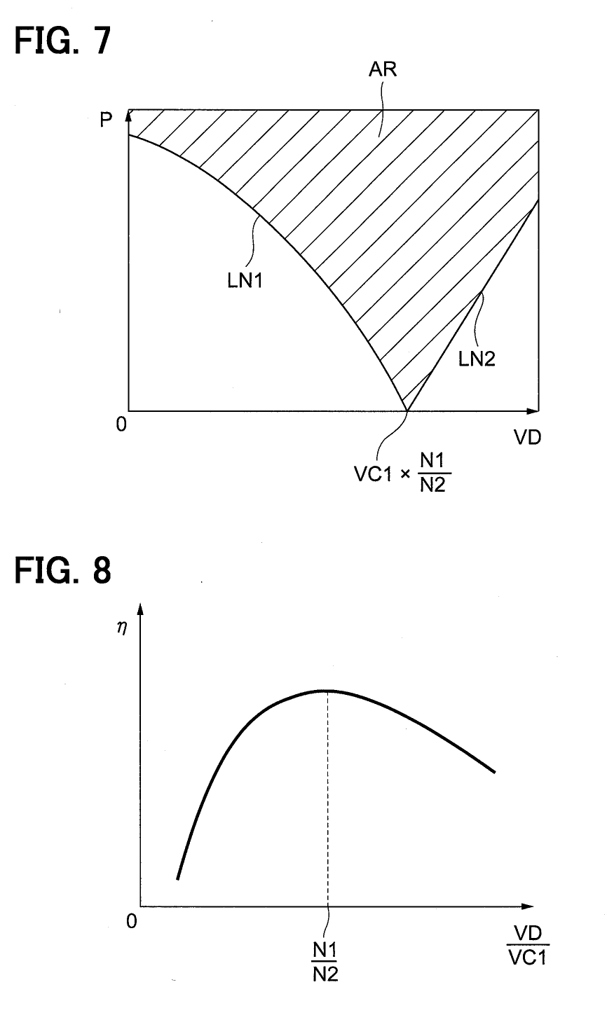

FIG. 7 is a graph showing a region, where a soft switching operation is possible; and

FIG. 8 is a graph showing an operation efficiency of the power conversion apparatus.

### EMBODIMENT

A power conversion apparatus will be descried below with reference to one exemplary embodiment shown in the drawings. For easy understanding, same structural parts are designated with same reference numerals as much as possible among the drawings thereby to simplify the description.

Referring to FIG. 1 a power conversion apparatus 10 is exemplified as being provided between a storage battery BT and an AC power source PS. The power conversion apparatus 10 converts AC power supplied from the AC power source PS to DC power and supplies and charges the storage battery BT with the DC power. In this case, it is also possible to provide an electric device (DC load), which operates with the DC power, to supply the DC power from the power conversion apparatus 10 to the electric device in place of the storage battery BT.

The power conversion apparatus 10 also converts DC power supplied from the storage battery BT to AC power and outputs the AC power to the AC power source PS side. In this case, it is also possible to provide an electric device (AC load), which operates with the AC power, to supply the AC power from the power conversion apparatus 10 to the electric device in place of the AC power source PS.

That is, the power conversion apparatus 10 is configured to be able to bilaterally convert electric power between a DC device such as the storage battery BT or the DC load and an AC device such as the AC power source PS or the AC load. The power conversion apparatus 10 includes a first conversion part 100, a second conversion part 200, a connection switchover part 300 and a control part 400, which is an electronic control unit (ECU).

The first conversion part 100 is an electric circuit for performing bilateral power conversion described above. The first first conversion part 100 includes a filter circuit part 110, a DC/DC conversion circuit part 120, a smoothing capacitor 130, an AC/DC conversion circuit part 140 and a filter circuit part 150.

The filter circuit part 110 is a low-pass filter (LPF) and provided between the storage battery BT and the DC/DC conversion circuit part 120 to filter out high-frequency components included in the DC voltage supplied thereto. The filter circuit part 110 is provided with a pair of terminals 111 and 112, which are input and output terminals at the storage battery BT side, and a pair of terminals 113 and 114, which are input and output terminals at the DC/DC conversion circuit part 120 side. The terminal 111 is connected to a positive terminal (high-potential side) of the storage battery BT and the terminal 112 is connected to a negative terminal (low-potential side) of the storage battery BT.

The DC/DC conversion circuit part 120 is configured to convert a voltage of the DC power supplied from the storage battery BT through the filter circuit part 110 and output converted power to the AC/DC conversion circuit part 140 side. The DC/DC conversion circuit part 120 is also configured to convert a voltage of the DC power supplied from the AC/DC conversion circuit part 140 side and output converted power to the filter circuit part 110 side. The DC/DC conversion circuit part 120 is provided with a pair of terminals 121 and 122, which are input and output terminals at the filter circuit part 110 side, and a pair of terminals 123 and 124, which are input and output terminals at the AC/DC conversion circuit part 140 side. The terminal 121 is connected to the terminal 113 of the filter circuit part 110 and the terminal 122 is connected to the terminal 114 of the filter circuit part 110.

As shown in FIG. 2, a transformer T1 is provided in the DC/DC conversion circuit part 120. In the DC/DC conversion circuit part 120, a part between a coil L1 of the transformer T1 and the terminals 121 and 122 form a full-bridge inverter circuit, which is formed of four switching elements Q1, Q2, Q3 and Q4 and diodes connected to these switching elements in parallel and in reverse-biased manner, respectively. Similarly, in the DC/DC conversion circuit part 120, a part between a coil L2 of the transformer T1 and the terminals 123 and 124 forms a full-bridge inverter circuit, which is formed of four switching elements Q5, Q6, Q7 and Q8 and diodes connected to these switching elements in parallel and in reverse-biased manner, respectively.

When the DC power is supplied from the terminals 121 and 122, the switching elements Q1, Q2, Q3 and Q4 are switched over to turn on and off by the control part 400 as described below and an AC current in a rectangular waveform flows in the coil L1 of the transformer T1. An AC current in a rectangular waveform correspondingly flows in the coil L2 of the transformer T1.

By switching over the switching elements Q5, Q6, Q7 an Q8 to turn on and off by the control part 400, the AC current supplied from the coil L2 is converted into the DC power and outputted from the terminals 123 and 124 to the AC/DC conversion circuit part 140 side. The DC power supplied from the terminals 123 and 124 is provided by voltage conversion (step-up or step-down) of the DC power supplied from the terminals 121 and 122.

A magnitude of the outputted voltage varies with a ratio of turns (turn ratio) of coils L1 and L2 of the transformer T1, switching periods of the switching elements Q1 to Q8, duty ratio and the like. The DC power supplied to the terminals 123 and 124 is also subjected to voltage conversion and outputted from the terminals 121 and 122 in the similar manner as described above. The switching operation performed in the full-bridge inverter circuit is not detailed, because it is known well.

Referring back to FIG. 1, the AC/DC conversion circuit part 140 is configured to convert the DC power supplied from the DC/DC conversion circuit part 120 into the AC power and the resulting AC power is outputted to the filter circuit part 150 side. The AC/DC conversion circuit part 140 is configured to convert the AC power supplied from the AC power source PS through the filter circuit part 150 into the DC power and output the resulting DC power to the DC/DC conversion circuit part 120 side. The AC/DC conversion circuit part 140 is provided with a pair of terminals 141 and 142, which are input and output terminals at the DC/DC conversion circuit part 120 side, and a pair of terminals 143 and 144, which are input and output terminals at the filter circuit part 150 side. The terminal 141 is connected to the terminal 123 of the DC/DC conversion circuit part 120 and the terminal 142 is connected to the terminal 124 of the DC/DC conversion circuit part 120.

The AC/DC conversion circuit part 140 is a full-bridge inverter circuit, which is formed of four switching elements (not shown) and diodes (not shown) connected to these switching elements in parallel and in reverse-biased manner. This configuration is known well and hence its internal configuration is not described nor shown.

The smoothing capacitor 130 is provided between a line connecting the terminal 123 and the terminal 141, which are at the high-potential side, and a line connecting the terminal 124 and the terminal 142, which are at the low-potential side. The smoothing capacitor 130 smoothes waveforms of the current and the voltage of the power supplied from the DC/DC conversion circuit part 120 to the AC/DC conversion circuit part 140 as well as the power supplied oppositely. An inter-terminal voltage between the terminal 123 and the terminal 124 and an inter-terminal voltage between the terminal 141 and the terminal 142 are the same as the voltage applied to the smoothing capacitor 130.

The filter circuit part 150 is a low-pass filter, which is configured similarly to the filter circuit part 110, and provided to filter out high frequency components from the current between the AC power source PS and the AC/DC conversion circuit part 140. The filter circuit part 150 is provided with a pair of terminals 151 and 152, which are input and output terminals at the AC/DC conversion circuit part 140 side, and a pair of terminals 153 and 154, which are input and output terminals at the AC power source PS side. The terminal 151 is connected to the terminal 143 of the AC/DC conversion circuit part 140 and the terminal 152 is connected to the terminal 144 of the AC/DC conversion circuit part 140.

The second conversion 200 is also an electric circuit, which is configured similarly to the first conversion part 100 described above. The second conversion part 200 is therefore not described in detail. In the following description, structural components of the second conversion part 200 corresponding to the structural components of the first conversion part 100 are designated with reference numerals of two hundreds, like a DC/DC converter 220.

A terminal 211 of a filter circuit part 210 is connected to the positive terminal of the storage battery BT and a terminal 212 is connected to the negative terminal of the storage battery BT. Terminals 253 and 254 of a filter circuit 250 are supplied or outputted with the AC power from the AC power source PS. As described above, the first conversion part 100 and the second conversion 200 are provided in parallel to each other.

The AC power source PS is described before description about function and configuration of the connection switchover part 300. The AC power source PS is an AC power source of a single-phase three-line type, which has three output terminals (OP1, OP2 and OP3). When the output terminal OP1 and the output terminal OP2 are connected to a load, AC power of 100 volts is supplied to the load. When the output terminal OP2 and the output terminal OP3 are connected to a load, AC power of 100 volts (effective value) is supplied to the load similarly. When the output terminal OP1 and the output terminal OP3 are connected to a load, however, AC power of 200 volts (effective value) is supplied to the load.

The connection switchover part 300 is provided between the AC power source PS and the filter circuit part 150 and filter circuit part 250. The connection switchover part 300 is formed of six relays R1, R2, R3, R4, R5 and R6. By switching over relay states, connection between the first conversion part 100 and the AC power source PS and connection between the second conversion 200 and the AC power source PS are switched over.

Specifically, states of connection are switched over between a first state and a second state. In the first state, the terminal 153, the terminal 154, the terminal 253 and the terminal 254 are connected to the output terminal OP1, the output terminal OP2, the output terminal OP2 and the output terminal OP3, respectively. In the second state, the terminal 153, the terminal 154, the terminal 253 and the terminal 254 are connected to the output terminal OP1, the output terminal OP3, the output terminal OP1 and the output terminal OP3, respectively.

In the first state, the AC power of 100 volts of the AC power source PS is supplied to the first conversion part 100, specifically the filter circuit part 150. The AC power of 100 volts of the AC power source PS is also supplied to the second conversion part 200, specifically the filter circuit part 250. In this case, the relays R1, R2, R3 and R4 are closed (ON) and the relays R5 and R6 are open (OFF).

In the second state, the AC power of 200 volts of the AC power source PS is supplied to the first conversion part 100, specifically the filter circuit part 150. The AC power of 200 volts of the AC power source PS is also supplied to the second conversion 200, specifically the filter circuit part 250. In this case, the relays R1, R3, R5 and R6 are closed (ON) and the relays R2 and R4 are open (OFF). The relays are switched over between ON and OFF under control by the control part 400.

The control part 400 is a computer formed of a CPU, a ROM, a RAM and an input/output interface and configured to control entire operations of the power conversion apparatus 10. Although not shown, the relays R1, R2, R3, R4, R5 and R6 are connected to the control part 400 through signal lines, respectively. Further, plural sensors (voltmeter VA1, ammeter IA1, for example) provided in the power conversion apparatus 10 are connected to the control part 400 through signal lines, respectively.

Voltmeters and ammeters provided at various points in the circuits forming the power conversion apparatus 10 will be described next. A voltmeter VA1 is a sensor, which measures a voltage between a line connected to the output terminal OP1 and a line connected to the output terminal OP2. A voltmeter VA2 is a sensor, which measures a voltage between the line connected to the output terminal OP2 and a line connected to the output terminal OP3. A voltmeter VA3 is a sensor, which measures a voltage between the line connected to the output terminal OP1 and the line connected to the output terminal OP3. Voltage values measured by the voltmeters VA1, VA2 and VA3 are inputted to the control part 400.

An ammeter IA1 is a sensor, which measures a current inputted and outputted at the terminal 153 of the filter circuit part 150. An ammeter IA2 is a sensor, which measures a current inputted and outputted at the terminal 253 of the filter circuit part 250. Current values measured by the ammeters IA1 and IA2 are inputted to the control part 400.

A voltmeter VC1 is a sensor, which measures a voltage applied to the smoothing capacitor 130. A voltmeter VC2 is a sensor, which measures a voltage applied to the smoothing capacitor 230. Voltage values measured by the voltmeters VC1 and VC2 are inputted to the control part 400.

An ammeter ID1 is a sensor, which measures a current inputted and outputted at the terminal 111 of the filter circuit part 110. An ammeter ID2 is a sensor, which measures a current inputted and outputted at the terminal 211 of the filter circuit part 210. Current values measured by the ammeters ID1 and ID2 are inputted to the control part 400.

The voltmeter VD is a sensor, which measures a voltage between the terminal 111 and the terminal 112 of the filter circuit part 110. As understood from FIG. 1, the voltmeter VD is also a sensor, which measures a voltage between the terminal 211 and the terminal 212 of the filter circuit part 210. A voltage value detected by the voltmeter VD is inputted to the control part 400.

As a requirement for the AC/DC conversion circuit part 140 to perform the power conversion operation normally, the DC voltage between the terminal 141 and the terminal 142 need be lower than a maximum value (peak voltage) of the AC voltage between the terminal 143 and the terminal 144 and also between the terminal 153 and the terminal 154.

For this reason, when the AC voltage of the effective value of 200 volts is supplied between the terminal 153 and the terminal 154, the AC/DC conversion circuit part 140 does not operate normally unless the DC voltage between the terminal 141 and the terminal 142 is about 280 volts or more.

The DC/DC conversion circuit part 220 needs to perform power conversion for producing a voltage, which is larger than a maximum value of the AC voltage between the terminal 153 and the terminal 154. In the present embodiment, the maximum value of the AC voltage between the terminal 153 and the terminal 154 is about 140 volts in the first state and about 280 volts in the second state.

The voltage of power supplied from the storage battery BT to the power conversion apparatus 10, that is, the voltage measured by the voltmeter VD, varies with a quantity of charge stored in the storage battery BT. When this voltage is low, the DC/DC conversion circuit part 120 needs to step up the voltage inputted from the filter circuit part 110 and output it to the AC/DC conversion circuit part 140 side. However, the conversion efficiency of the DC/DC conversion circuit part 120 is remarkably lowered in some instances depending on the magnitude of the voltage measured by the voltmeter VD. This is also true for the DC/DC conversion circuit part 220.

This point will be explained with reference to FIG. 3. FIG. 3 shows changes in switching operations of the switching elements (Q1, etc., for example) and changes in a current flowing in the transformer T1 (current flowing in coil L1) in a period from time t0 to t8. In FIG. 3, (A) shows operations of the switching elements Q1 and Q4. (B) shows operations of the switching elements Q2 and Q3. (C) shows operations of the switching elements Q5 and Q8. (D) shows operations of the switching elements Q6 and Q7.

As shown in (A), the switching elements Q1 and Q4 are in the closed states (ON) during a period from time t0 to time t2 and in the open states (OFF) during a period from time t2 to time t4. This operation from time t0 to t4 is repeated after time t4. In the example shown in FIG. 3, the period from time t0 to time t2 and the period from time t2 to time t4 have the same length of time.

As shown in (B), the switching elements Q2 and Q3 are in the open states (OFF) during a period from time t0 to time t2 and in the closed states (ON) during a period from time t2 to time t4. This operation from time t0 to t4 is repeated after time t4. Thus the switching elements Q2 and Q3 are switched over to be always in the opposite states to the switching elements Q1 and Q4.

As shown in (C), the switching elements Q5 and Q8 are in the closed states (ON) during a period from time t1 to time t3 and in the open states (OFF) during a period from time t3 to time t5. This operation from time t1 to time t5 is repeated after time t5. Time t1 is delayed by a period φ from time t0. The period from time t1 to time t3 and the period from time t3 to time t5 have the same length of time. That is, the operations of the switching elements Q5 and Q8 shown in (C) correspond to the operations of the switching elements Q1 and Q4 shown in (A) with the time delay period φ.

As shown in (D), the switching elements Q6 and Q7 are in the open states (OFF) during a period from time t1 to time t3 and in the closed states (ON during a period from time t3 to time t5. This operation from time t1 to time t5 is repeated after time t5. Thus the switching elements Q6 and Q7 are switched over to be always in the opposite states to the switching elements Q5 and Q8. The operations of the switching elements Q6 and Q7 shown in (D) correspond to the operations of the switching elements Q2 and Q3 shown in (B) with the time delay period φ.

When the switching elements Q1 to Q8 are switched over as described below, currents flow in the coils of the transformer T1 in the rectangular waveforms, respectively. (E) shows a change in the current, which flows in the coil L1, in a case that a ratio between the voltage measured by the voltmeter VD (referred to as voltage VD) and the voltage measured by the voltmeter VC1 (referred to as voltage VC1) is equal to a ratio between the number of turns N1 of the coil L1 of the transformer T1 (referred to as turn number N1) and the number of turns of the coil L2 of the transformer T1 (referred to as turn number N2).

In such a case that the voltage VC1 satisfies the following equation (Eq), the waveform of the current flowing in the coil L1 is a flat rectangular waveform.

VC1=VD×N2/N1 (Eq)

That is, as shown in (E), a constant current I1 flows during the period from time t1 to time t2 and a constant current −I1 flows in the opposite direction during the period from time t3 to time t4. At time t3 and time t4, at which the switching elements Q1, etc. are switched over, the direction of current flow at time t2 and the direction of current flow at time t3 are opposite. As a result, soft switching is performed in the period from time t2 to time t3 and hence the operation efficiency of the DC/DC conversion circuit part 120 is very excellent. This is also true in other periods (from time t4 to time t5, for example), in which the switching elements Q1, etc. are switched over.

When a value of the voltage VC1 is calculated based on the equation (Eq) under a state that the stored charge of the storage battery BT decreases and the voltage correspondingly decreases, the voltage VC1 tends to decrease to be lower than a maximum value of the AC voltage between the terminals 143 and 144. In this case, as described above, the AC/DC conversion circuit part 140 cannot operate normally. The DC/DC conversion circuit part 120 or the AC/DC conversion circuit part 140 is required to perform the voltage conversion so that the voltage VC1 becomes larger than a value calculated by the equation (Eq).

(F) shows this case, that is, a change in the current flowing in the coil L1 when the voltage ratio between the voltage VD and the voltage VC1 is not equal to the turn ratio between the turn number N1 and the turn number N2. In this case, differently from (E), the waveform of the current flowing in the coil L1 becomes a flat rectangular waveform.

That is, the current tends to decrease in the period from time t1 to time t2 and increase in the period from time t3 and time t4. The maximum value I2 of the current at time t1 and time t5 becomes larger than the maximum value I1 of the current shown in (E). This phenomenon arises, because the transformer T1 generates a voltage, which is different from a voltage determined by the turn ratio N1/N2, at its both sides and the currents, which flow in the coils L1 and L2, change with elapse of time.

As a result of a large decrease in the current in the period from time t1 to time t2, the current continues to flow in the same direction in the period from time t2 to time t3. For this reason, the soft switching is not performed in the period from time t2 to time t3. As a result, the operation efficiency of the DC/DC conversion circuit part 120 is lowered because of hard switching. This is also true in other periods (from time t4 to time t5, for example), in which the switching elements Q1, etc. are switched over.

Further, since the maximum values of the currents, which flow in the coils L1 and L2), increase, the copper loss in the transformer T1 increases. The operation efficiency of the DC/DC conversion circuit part 120 is thus lowered.

As described above, when the voltage VD inputted from the storage battery BT decreases, the operation efficiency of the DC/DC conversion circuit part 120 tends to correspondingly decrease remarkably. Accordingly, in the present embodiment, the power conversion apparatus 10 is configured to avoid the decrease of the operation efficiency described above by switching over connections between the first conversion part 100 and the AC power source PS by the connection switchover part 300.

A control operation performed by the control part 400 will be described next with reference to FIG. 4. The control part 400 is configured to perform the processing shown in FIG. 4 at every predetermined interval.

It is checked at step S01 whether the voltage measured by the voltmeter VA3 (referred to as voltage VA3) is larger than a value, which is a product (multiplication) of the voltage VD and the turn ratio N2/N1 between the turn numbers N1 and N2. When the voltage VA3 is larger than the product of the voltage VD and the turn ratio N2/N1, that is, VA3>VD×N2/N1, step S02 is executed.

Step S02 is executed, when it is not possible to perform the operation shown in (E) if the voltage V3 (200 volts) is supplied between the terminal 153 and the terminal 154. That is, since the voltage VD is relatively small, it is necessary to make the voltage VC1 to be larger than a value calculated by the equation (Eq) to satisfy the requirement for the normal operation of the AC/DC conversion circuit part 140, that is, the voltage between terminals 141 and 142 is larger than the voltage between terminals 143 and 144.

For this reason, at step S02, the switching element Q1, etc. are switched over to attain the first state. Specifically, the relays R1, R2, R3 and R4 are switched over to the closed states (ON) and the relays R5 and R6 are switched over to the open states (OFF). Thus it is made possible to supply the AC power of 100 volts from the AC power source PS to the first conversion part 100, specifically to the filter circuit part 150. It is also made possible to supply the AC power of 100 volts from the AC power source PS to the second conversion part 200, specifically to the filter circuit part 250.

With the connection switchover part 300 operating as described above, the AC voltage between the terminals 143 and 144 becomes 100 volts (effective value). As a result, even in a case that the voltage VC1 is the voltage calculated by the equation (Eq), it is possible to satisfy the requirement for operating the AC/DC conversion circuit part 140 normally, that is, the voltage between the terminals 141 and 142 is larger than the voltage between the terminals 143 and 144.

After switchover of the states of the switching elements Q1, etc. at step S02, the DC/DC conversion circuit part 120 or the AC/DC conversion circuit part 140 operates so that the voltage VC1 attains a value, which satisfies the equation (Eq). Similarly, the DC/DC conversion circuit part 220 or the AC/DC conversion circuit part 240 also operates so that the voltage VC1 attains a value, which satisfies the equation (Eq). Thus the soft switching is performed in each of the DC/DC conversion circuit part 120 and the DC/DC conversion circuit part 220 and the operation efficiencies of the DC/DC conversion circuit part 120 and the DC/DC conversion circuit part 220 are improved.

When the voltage VA3 is equal to or smaller than the product of the voltage VD and the turn ratio N2/N1, that is, VA3≦VD×N2/N1 at step S01, step S03 is executed.

Step S03 is executed, when it is possible to perform the operation shown in (E) even if the voltage V3 (200 volts) is supplied between the terminal 153 and the terminal 154. That is, since the voltage VD is relatively large, it is possible to make the voltage VC1 to be a value calculated by the equation (Eq) while satisfying the requirement for the normal operation of the AC/DC conversion circuit part 140, that is, the voltage between the terminals 141 and 142 is larger than the voltage between the terminals 143 and 144.

Thus, at step S03, the switching elements Q1, etc. are switched over to attain the second state. Specifically, the relays R1, R3, R5 and R6 are switched over to the closed states (ON) and the relays R2 and R4 are switched over to the open states (OFF). Thus it is made possible to supply the AC power of 200 volts from the AC power source PS to the first conversion part 100, specifically to the filter circuit part 150. It is also made possible to supply the AC power of 200 volts from the AC power source PS to the second conversion part 200, specifically to the filter circuit part 250.

With the connection switchover part 300 operating as described above, the AC voltage between the terminals 143 and 144 becomes 200 volts. As a result, it is possible to satisfy the requirement for operating the AC/DC conversion circuit part 140 normally, that is, the voltage between the terminals 141 and 142 is larger than the voltage between the terminals 143 and 144, while making the voltage VC1 to be the voltage calculated by the equation (Eq).

After switchover of the states of the switching elements Q1, etc. at step S03, the DC/DC conversion circuit part 120 or the AC/DC conversion circuit part 140 operates so that the voltage VC1 attains a value, which satisfies the equation (Eq). Similarly, the DC/DC conversion circuit part 220 or the AC/DC conversion circuit part 240 also operates so that the voltage VC1 attains a value, which satisfies the equation (Eq). Thus the soft switching is performed in each of the DC/DC conversion circuit part 120 and the DC/DC conversion circuit part 220 and the operation efficiencies of the DC/DC conversion circuit part 120 and the DC/DC conversion circuit part 220 are improved.

As described above, in the power conversion apparatus 10 according to the present embodiment, the maximum value of the AC voltage supplied to the first conversion part 100 is varied by switching over the connection states between the terminals 153, 154 (AC input and output part) and the AC power source PS (AC device) by the connection switchover part 300. That is, the relays R1, etc. are switched over by the connection switchover part 300 so that the maximum value of the AC voltage between the terminals 153 and 154 does not exceed a value, that is, an upper limit voltage value, which is determined by multiplication of the voltage VD (DC voltage between terminals 111 and 112) by the turn ratio N2/N1.

With the above-described operation of the connection switchover part 300, the power conversion apparatus 10 can maintain the operation at high efficiency even when the voltage VD, which is supplied from the storage battery BT, varies largely.

The connection switchover part 300 thus operates to minimize a difference between the upper limit voltage value and the maximum value of the AC voltage between the terminals 153 and 154. That is, the connection switchover part 300 operates to provide a connection state out of two possible connection states (first state and second state), which minimizes the difference between the upper limit voltage value and the maximum value of the AC voltage between the terminals 153 and 154.

As far as the connection switchover part 300 operates as described above to minimize the voltage difference, the power conversion apparatus 100 can provide its advantage (although less advantageous than the present embodiment) even in a case that, after the above-described operation of the connection switchover part 300, the maximum value of the AC voltage between the terminals 153 and 154 becomes smaller than the upper limit voltage value, which is determined by multiplication of the voltage VD (DC voltage between terminals 111 and 112) and the turn ratio N2/N1 between the coil L1 and the coil L1.

The processing shown in FIG. 4 and the operation of the connection switchover part 300 described above are performed in either case of the power supply from the AC power source PS side to the storage battery BT side (referred to as AC-DC conversion time) and the power supply from the storage battery BT side to the AC power source PS side (referred to as DC-AC conversion time). It is noted however that, for controlling the voltage VC1 to attain the value VC1 calculated by the equation (Eq), the DC/DC conversion circuit part 120 or the AC/DC conversion circuit part 140 needs to perform different processing between the AC/DC conversion time and the DC/AC conversion time.

In the AC/DC conversion time, the AC/DC conversion circuit part 140 performs its switching operation to maintain the voltage VC1 at the value calculated by the equation (Eq). FIG. 5 shows in a block diagram processing performed by the control part 400 to calculate a duty ratio Duty of the switching operation performed in the AC/DC conversion circuit part 140 at the AC/DC conversion time.

First, a value VD×N2/N1, in which VD is the voltage and N1 and N2 are turn numbers of the coils L1 and L2, is calculated by a multiplier ML11. This value is a target value of the voltage VC1. Then a value of the voltage VC1, which is actually measured, is subtracted from the target value by an adder AD11. A calculated value, that is, a difference (deviation) of the voltage VC1 from the target value, is inputted to an arithmetic calculator (proportional and integral calculator) PI11.

By the arithmetic calculator PI11, a magnitude of a current required to reduce the difference to 0 (current drawn from source PS side) is calculated based on the value of the inputted difference.

By a multiplier ML 12, a present-time value of a sine wave, which has the value calculated by the arithmetic calculator PI11 as its maximum value, is calculated. Specifically, the value calculated by the arithmetic calculator PI11 is multiplied by a value of the sine wave outputted from a unit waveform generator SI. An output value calculated by the multiplier ML12 is a target value of the current, which is drawn from the AC power source PS side to the power conversion apparatus 10.

By an adder AD12, a current value (referred to as current IA1) detected by the ammeter IA1 is subtracted from the output value of the multiplier ML 12. A calculated value, that is, a difference of the current IA1 drawn from the AC power source PS, is inputted to an arithmetic calculator PI12.

By the arithmetic calculator PI12, a duty ratio Duty required to reduce an inputted difference to 0 is calculated based on a value of the inputted difference. That is, a duty-controlled switching signal for turning on and off each switching element (not shown) of the AC/DC conversion circuit part 140 is determined and outputted. In the AC/DC conversion circuit part 140, each switching element is switched over to turn on and off in response to the switching signal to perform power conversion. Thus the voltage VC1 is maintained at the value calculated by the equation (Eq). The same operation is performed in the AC/DC conversion circuit part 240.

In the DC/AC conversion time, the DC/DC conversion circuit part 120 performs its switching operation to maintain the voltage VC1 at the value calculated by the equation (Eq). FIG. 6 shows in a block diagram processing performed by the control part 400 to calculate a duty of the switching operation performed in the DC/DC conversion circuit part 120 at the DC/AC conversion time.

First, a value VD×N2/N1, in which VD is the voltage and N1 and N2 are turn numbers of the coils L1 and L2, is calculated by a multiplier ML21. This value is a target value of the voltage VC1. Then a value of the voltage VC1, which is actually measured, is subtracted from the target value by an adder AD21. A calculated value, that is, a difference (deviation) of the voltage VC1 from the target value, is inputted to an arithmetic calculator PI21.

By the arithmetic calculator PI21, a magnitude of a current required to reduce the difference to 0 (current drawn from battery BT side) is calculated based on the value of the inputted difference. An output value calculated by the arithmetic calculator PI21 is a target value of the current, which is drawn from the storage battery BT side to the power conversion apparatus 10.

By an adder AD22, a current value (referred to as current ID1) calculated by the ammeter ID1 is subtracted from the output value of the arithmetic calculator PI21. A calculated value, that is, a difference of the current ID1 drawn from the storage battery BT side, is inputted to an arithmetic calculator PI22.

By the arithmetic calculator PI22, a duty ratio Duty required to reduce an inputted difference to 0 is calculated based on a value of the inputted difference. That is, a duty-controlled switching signal for turning on and off each switching element Q1 etc. of the DC/DC conversion circuit part 120 is determined and outputted. In the DC/DC conversion circuit part 120, each switching element is switched over to turn on and off in response to the switching signal to perform power conversion. Thus the voltage VC1 is maintained at the value calculated by the equation (Eq). The same operation is performed in the DC/DC conversion circuit part 220.

FIG. 7 shows a region AR, in which the power conversion apparatus 10 is capable of performing the soft switching. The abscissa axis and the ordinate axis of FIG. 7 indicate the voltage VD and power P outputted from the power conversion apparatus 10, respectively. A line LN1 and a line LN2 are a border of the secondary side and a border of the primary side, respectively. The region AR indicated at upper sides of the line LN1 and the line LN2 (area of large power outputted from power conversion apparatus 10) represents a region, in which the soft switching is attained.

As understood from FIG. 7, the range of power, in which the soft switching is possible, is widest when the voltage VD is equal to VC1×N1/N2, which is the product (multiplication) of the voltage VC1 by the turn ratio N1/N2, that is, when the voltage VC1 satisfies the equation (Eq).

FIG. 8 shows a relation between a voltage change and the operation efficiency η of the power conversion apparatus 10. The abscissa axis and the ordinate axis of FIG. 8 indicate a ratio of voltages VD/VC1 and the operation efficiency η of the power conversion apparatus 10. As understood from FIG. 8, the operation efficiency η of the power conversion apparatus 10 is the highest when the voltage ratio VD/VC1 equals the turn ratio N1/N2, that is, when the relation between the voltage VD and the voltage VC1 satisfy the equation (Eq).

As described above, in the power conversion apparatus 10, the DC/DC conversion circuit part 120 or the AC/DC conversion circuit part 140 operates to always satisfy the relation VD=VC1×N1/N2, that is, equation (Eq). Further, the connection switchover part 300 switches over the connection state between the power conversion apparatus 10 and the AC device so that the AC/DC conversion circuit part 140 operates normally while satisfying the equation (Eq).

In the present embodiment, the first conversion part 100 and the second conversion 200 are configured to have the same configurations and arranged in parallel. However, the power conversion apparatus 10 is not limited to the embodiment described above but may be configured to have only the first conversion part 100, for example. In such a modification, when the voltage VD falls and the power conversion apparatus is switched to the first state (when the AC voltage supplied between the terminals 153 and 154 becomes 100 volts), the power being capable of being supplied from the power conversion apparatus 10 to the storage battery BT or the AC power source PS side becomes smaller than that being capable of being supplied in the second state.

In the present embodiment, however, both of the first conversion part 100 and the second conversion 200 provided in parallel output respective power. As a result, it is possible to output sufficient power in any of the first state and the second state.

The relays R1 etc. in the connection switchover part 300 are preferably switched over when the AC voltage at the terminals 153 and the terminal 154 become 0 (at zero-cross timing). With the switchover at such timing, switching loss is reduced and the operation efficiency of the power conversion apparatus 10 is increased more. In this case, it is preferred to use power devices such as IGBT in place of mechanically-operable relays R1, etc. so that the switchover timing is controlled accurately.

What is claimed is:

1. A power conversion apparatus comprising:
an AC input and output part connectable to an AC device, which is either one of an AC power source and an AC load;
a DC input and output part connectable to a DC device, which is either one of a DC power source and a DC load;
an AC/DC conversion circuit part for converting AC power supplied from the AC input and output part into the DC power;
a DC/DC conversion circuit part including a transformer, the DC/DC conversion circuit for converting the DC power supplied from the AC/DC conversion circuit part into AC power, converting converted AC power into DC power after voltage conversion by the transformer and outputting converted DC power to the DC input and output part;
a smoothing capacitor provided in a connection part between the AC/DC conversion circuit part and the DC/DC conversion circuit part to smooth a voltage at the connection part; and
a connection switchover part for changing a maximum value of the AC voltage at the AC input and output part by switching over a connection state between the AC input and output part and the AC device.

2. The power conversion apparatus according to claim 1, wherein:
the connection switchover part is configured to switchover the connection state between the AC input and output part and the AC device so that the maximum value of the AC voltage at the AC input and output part is smaller than an upper limit voltage value, which is calculated by dividing the DC voltage at the DC input and output part by a turn number of a coil of the transformer at a DC input and output part side and multiplying by a turn number of a coil of the transformer at a smoothing capacitor side.

3. The power conversion apparatus according to claim 1, wherein:
the connection switchover part is configured to switchover the connection state between the AC input and output part and the AC device so that a difference between the maximum value of the AC voltage at the AC input and output part and an upper limit value is minimized, the upper limit value being calculated by dividing the DC voltage at the DC input and output part by a turn number of a coil of the transformer at a DC input and output part side and multiplying by a turn number of a coil of the transformer at a smoothing capacitor side.

4. The power conversion apparatus according to claim 2, wherein:
the AC/DC conversion circuit part or the DC/DC conversion circuit part is configured to perform power conversion so that a voltage ratio between the DC voltage at the DC input and output part and the DC voltage at the smoothing capacitor equals a turn ratio between the turn number of the coil of the transformer at the DC input and output side and the turn number of the coil of the transformer at the smoothing capacitor side.

5. The power conversion apparatus according to claim 2, wherein:
two power conversion parts, each of which includes the AC/DC conversion circuit part, the smoothing capacitor and the DC/DC conversion circuit part, are provided in parallel.

6. The power conversion apparatus according to claim 2, wherein:
the connection switchover part is configured to switchover the connection states between the AC input and output part and the AC device at a timing when the AC voltage at the AC input output part becomes 0 volt.

7. The power conversion apparatus according to claim 3, wherein:
the AC/DC conversion circuit part or the DC/DC conversion circuit part is configured to perform power conversion so that a voltage ratio between the DC voltage at the DC input and output part and the DC voltage at the smoothing capacitor equals a turn ratio between the turn number of the coil of the transformer at the DC input and output side and the turn number of the coil of the transformer at the smoothing capacitor side.

8. The power conversion apparatus according to claim 3, wherein:
two power conversion parts, each of which includes the AC/DC conversion circuit part, the smoothing capacitor and the DC/DC conversion circuit part, are provided in parallel.

9. The power conversion apparatus according to claim 3, wherein:
the connection switchover part is configured to switchover the connection states between the AC input and output part and the AC device at a timing when the AC voltage at the AC input output part becomes 0 volt.

10. The power conversion apparatus according to claim 1, further comprising:
a control part configured to compare the AC voltage at the AC input and output part with a limit voltage value, which is calculated by multiplying the DC voltage at the DC input and output part by a turn ratio between two coils of a transformer provided in the DC/DC conversion circuit part, and control the connection switchover part to switch over the connection states between the AC input and output part and the AC device in accordance with a result of comparison outputted from the control part.
